(19) United States
(12) Patent Application Publication
(10) Pub. No.: US 2011/0270542 A1
(43) Pub. Date: Nov. 3, 2011

(54) FLUID LEVEL SENSING SYSTEM

(75) Inventors: William Chappell, Royal Oak, MI (US); Harry Shappell, Clinton Township, MI (US); Adam Razz, New Baltimore, MI (US)

(73) Assignee: SSI Technology, Inc.

(21) Appl. No.: 12/771,577

(22) Filed: Apr. 30, 2010

(51) Int. Cl. G01F 23/26

(52) U.S. Cl. 702/55

(57) ABSTRACT

A system for monitoring the level of a fluid in a vehicle is provided. The system comprises a capacitance sensor configured to be at least partially immersed in the fluid. The capacitance sensor is configured to measure a first capacitance associated with a predetermined level of the fluid and a second capacitance associated with an actual level of the fluid in the vehicle. The system further comprises a processing circuit configured to determine the actual level of the fluid in the vehicle using the first capacitance and the second capacitance. The processing circuit is configured to receive at least one of an attitude of the vehicle and a temperature of the fluid from at least one sensor coupled to the vehicle. The processing circuit is further configured to compare the determined actual level of the fluid with a threshold level associated with the at least one of the attitude and temperature to identify a relative position of the determined actual level of the fluid with respect to the threshold level.

### BACKGROUND

The present disclosure relates generally to the field of fluid level sensing systems. The present disclosure relates more particularly to fluid level sensing systems for determining the level of a fluid in a vehicle.

Vehicles (e.g., automobiles, watercraft, aircraft, tanks, etc.) often require certain fluids to be changed to ensure continued operation and avoid maintenance problems. For example, if oil in a vehicle's engine is not changed before the level of the oil becomes low the engine may be damaged due to inadequate lubrication. One way to avoid such damage is to change the oil periodically (e.g., after a certain time (e.g., hours) or distance (e.g., miles) from the previous oil change). However, changing the oil after the passage of a certain amount of time or distance does not detect or prevent damage that may occur from a low oil level prior to the scheduled change point. Further, changing the oil according to a particular time or distance schedule may result in more frequent oil changes than necessary to maintain the engine. More frequent oil changes can cause substantial costs and time delays, particularly in vehicles with complex engines (e.g., aircraft, tanks, etc.) that may require complicated and expensive disassembly procedures for oil changes.

### SUMMARY

One embodiment of the disclosure relates to a system for monitoring the level of a fluid in a vehicle. The system comprises a capacitance sensor configured to be at least partially immersed in the fluid. The capacitance sensor is configured to measure a first capacitance associated with a predetermined level of the fluid and a second capacitance associated with an actual level of the fluid in the vehicle. The system further comprises a processing circuit configured to determine the actual level of the fluid in the vehicle using the first capacitance and the second capacitance. The processing circuit is configured to receive at least one of an attitude of the vehicle and a temperature of the fluid from at least one sensor coupled to the vehicle. The processing circuit is further configured to compare the determined actual level of the fluid with a threshold level associated with the at least one of the attitude and temperature to identify a relative position of the determined actual level of the fluid with respect to the threshold level.

Another embodiment relates to a method for monitoring a level of a fluid in a vehicle. The method comprises measuring a first capacitance using a capacitance sensor. The capacitance sensor is configured to be at least partially immersed in the fluid. The first capacitance is associated with a predetermined level of the fluid. The method further comprises measuring a second capacitance using the capacitance sensor. The second capacitance is associated with the actual level of the fluid in the vehicle. The method further comprises determining the actual level of the fluid in the vehicle based on the first capacitance and the second capacitance. The method further comprises receiving at least one of an attitude of the vehicle and a temperature of the fluid from at least one sensor coupled to the vehicle. The method further comprises comparing the determined actual level of the fluid with a threshold level associated with the at least one of the attitude and temperature to identify a relative position of the determined actual level with respect to the threshold level.

Yet another embodiment relates to a system for monitoring a level of a non-conductive fluid in a vehicle. The system comprises a capacitance sensor configured to be at least partially immersed in the fluid. The capacitance sensor comprises an outer tube and an inner tube. The outer tube is concentric and coaxial with the inner tube. The inner tube comprises a main probe and a reference probe. The main probe is positioned above the reference probe and is coupled to and electrically isolated from the reference probe by an insulator. The reference probe is configured to be completely immersed in the fluid. The capacitance sensor is configured to measure a first capacitance and a second capacitance. The first capacitance is associated with a predetermined level of the fluid and the second capacitance is associated with the actual level of the fluid in the vehicle. The main probe is electrically coupled to the outer tube to measure the first capacitance and the first capacitance is measured across the reference probe and the combination of the main probe and the outer tube. The main probe is electrically coupled to the reference probe to measure the second capacitance and the second capacitance is measured across the outer tube and the combination of the main probe and reference probe. The system further comprises a conversion circuit configured to convert the first capacitance and the second capacitance to digital signals. The system further comprises a processing circuit configured to determine the actual level of the fluid using the digital signals representing the first capacitance and the second capacitance. The processing circuit is configured to receive at least one of an attitude of the vehicle and a temperature of the fluid from at least one sensor coupled to the vehicle. The processing circuit includes a memory configured to store a plurality of threshold level data elements. Each threshold level data element represents a threshold level of the fluid corresponding to different values of the at least one of the attitude and temperature. The processing circuit is configured to retrieve a threshold level data element corresponding to a value of the at least one of the attitude and temperature similar to the value of the at least one of the attitude and temperature received from the at least one sensor. The processing circuit is configured to compare the determined actual level of the fluid with the retrieved threshold level data element to identify a relative position of the determined actual level of the fluid with respect to the threshold level.

### BRIEF DESCRIPTION OF THE DRAWINGS

FIG. 1 is a block diagram of a system for determining a level of a fluid in a vehicle according to an exemplary embodiment.

FIG. 2A is a perspective view of a fluid level sensor according to an exemplary embodiment.

FIG. 2B is a perspective view of a fluid level sensor according to another exemplary embodiment.

FIGS. 2C AND 2D are perspective views of a fluid level sensor partially immersed in a fluid according to exemplary embodiments.

FIGS. 3A, 3B and 3C are views of electrical connections to a fluid level sensor according to an exemplary embodiment.

FIG. 3D is a graph of the capacitance measured by the fluid level sensor shown in FIGS. 3A through 3C at different fluid levels according to an exemplary embodiment.

FIG. 4 is a detailed block diagram of a system for determining a level of a fluid in a vehicle according to an exemplary embodiment.

FIG. 5 is a table that may be stored in the memory of the processing circuit shown in FIGS. 1 and 4 according to an exemplary embodiment.

FIG. 6A is a flow diagram of a process for determining a level of a fluid in a vehicle according to an exemplary embodiment.

FIG. 6B is a more detailed flow diagram of a process for determining a level of a fluid in a vehicle according to an exemplary embodiment.

### DETAILED DESCRIPTION

Referring generally to the Figures, a system for determining a level of a fluid in a vehicle is shown and described, according to various exemplary embodiments. The system includes a capacitance sensor in contact with the fluid and configured to measure a reference capacitance (i.e., the capacitance associated with a predetermined level of the fluid) and a total probe capacitance (i.e., the capacitance associated with an actual level of the fluid rise above reference). The system also includes a processing circuit configured to determine the actual level of the fluid based on the reference capacitance and total probe capacitance. The processing circuit is also configured to receive measurements from attitude and/or temperature sensors and use the attitude and/or temperature inputs and data stored in a memory to determine if the fluid is below a threshold level. The use of such a system may allow a user to change the fluid only when necessary, rather than after a set time or usage distance, reducing the cost and downtime sometimes associated with changing fluid in vehicles. Further, various embodiments may allow for calculation of the fluid level and/or alarms presented to a user of the vehicle to account for differences between fluid types, changes in fluid condition, attitude of the vehicle, temperature of the fluid, and/or other conditions.

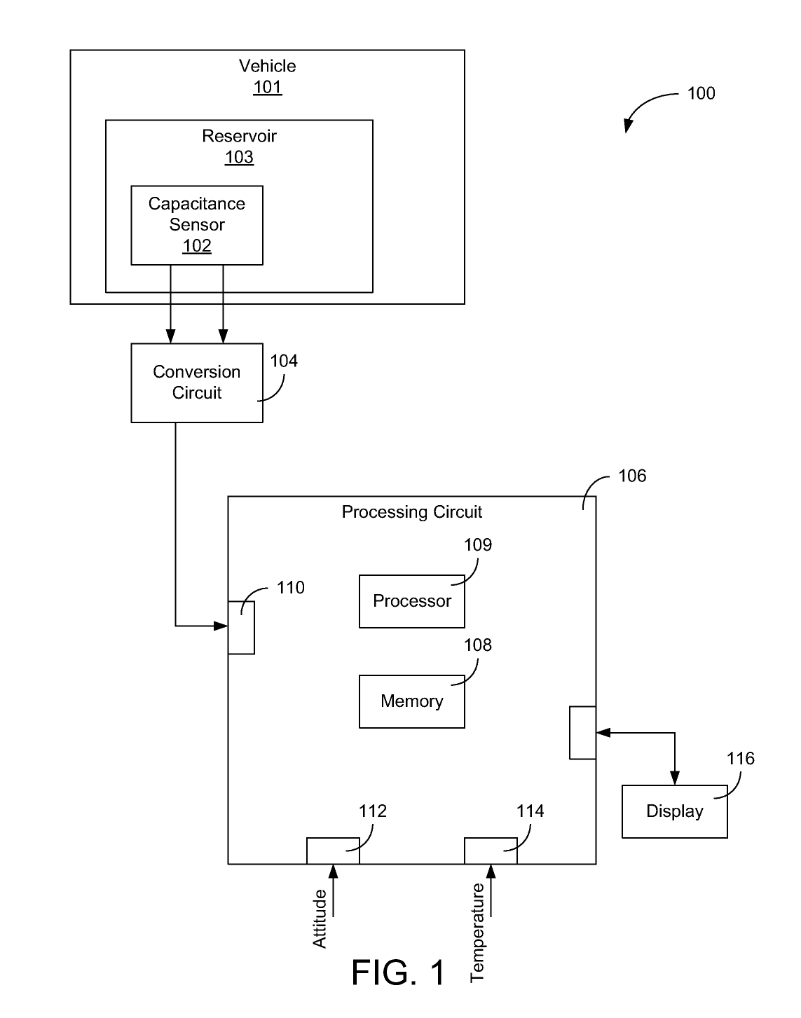

Referring now to FIG. 1, a block diagram of a system 100 for determining a level of a fluid in a vehicle 101 is shown according to an exemplary embodiment. System 100 may be used to determine the level of any non-conductive fluid which has a dielectric constant different than air (e.g., oil, fuel, etc.) in vehicle 101.

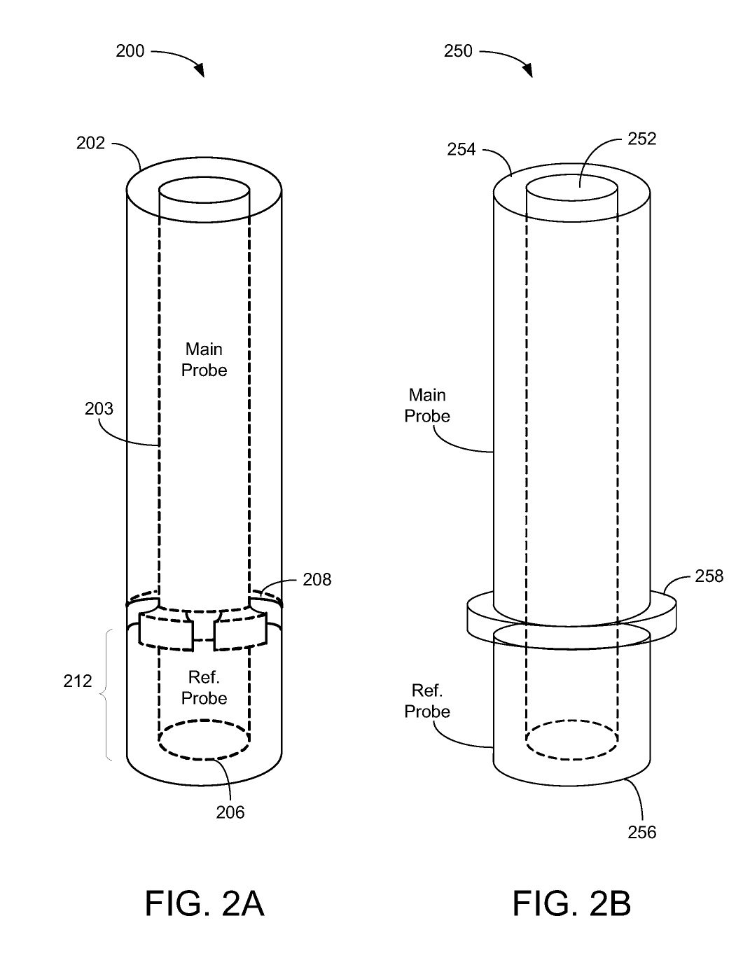

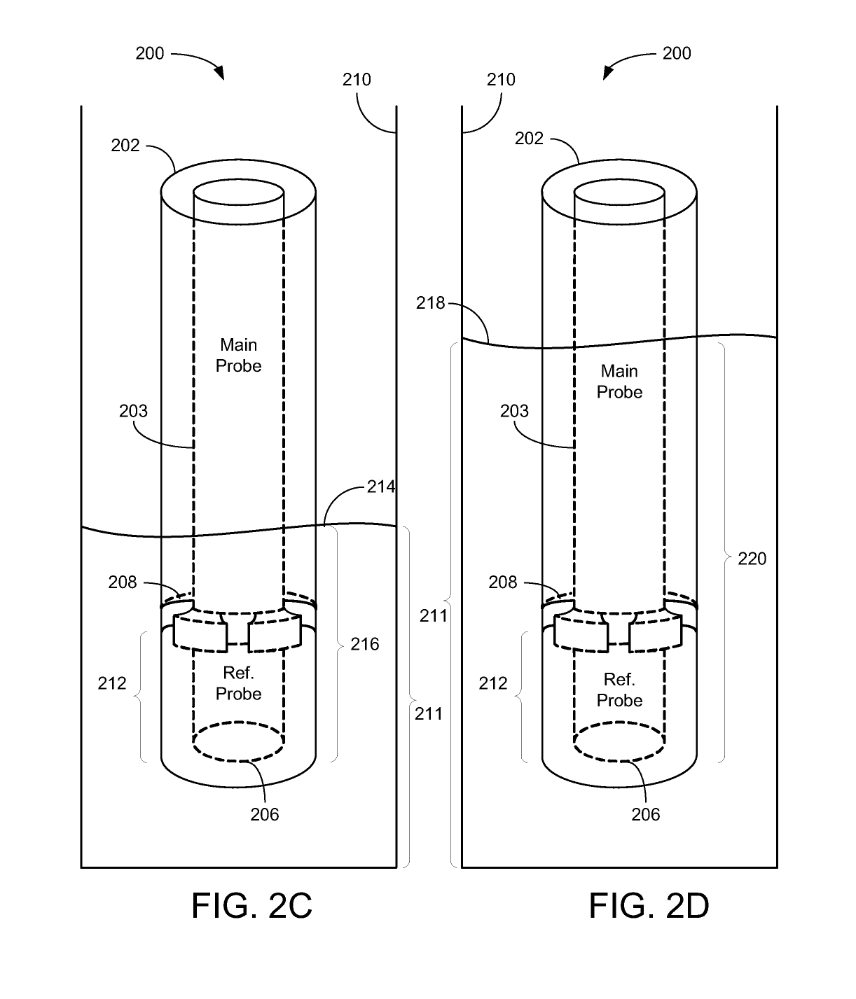

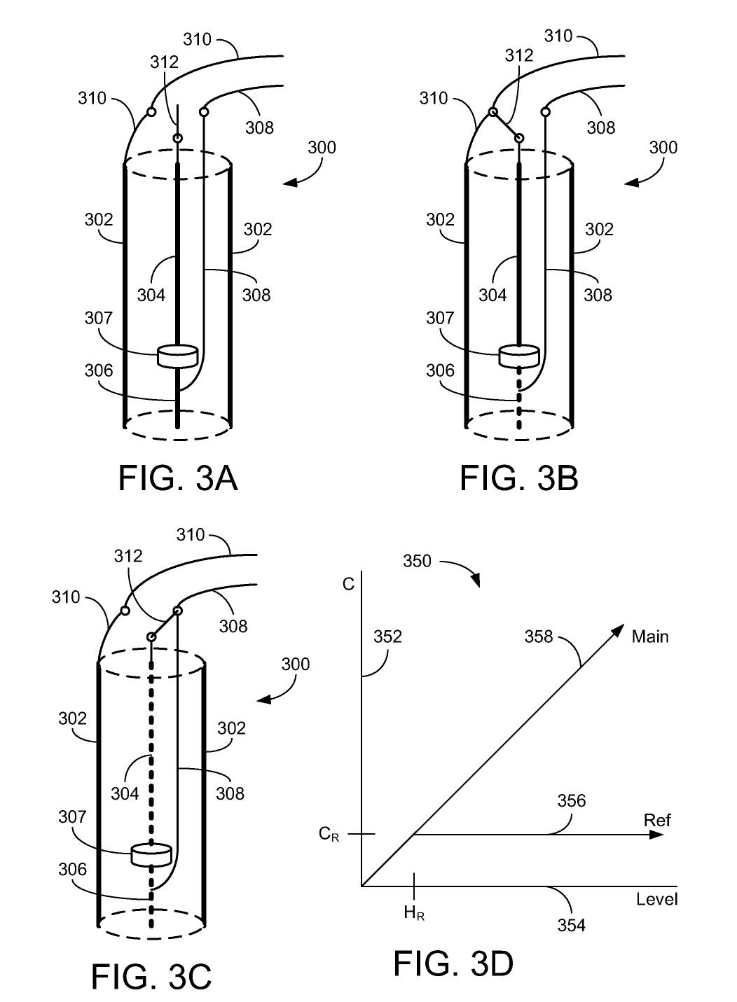

System 100 includes a capacitance sensor 102, a conversion circuit 104, and a processing circuit 106. Capacitance sensor 102 is positioned in a fluid reservoir 103 containing the fluid and is at least partially immersed in the fluid. Capacitance sensor 102 is configured to measure a reference capacitance for a predetermined level of the fluid (e.g., 0.5″, 0.75″, 1″, etc. above the bottom of capacitance sensor 102). Capacitance sensor 102 is further configured to measure a total probe capacitance for the actual level of the fluid (e.g., the height of the actual fluid level above the bottom of capacitance sensor 102). Structural and electrical characteristics of capacitance sensor 102, according to exemplary embodiments, are described below with reference to FIGS. 2A through 3D.

Conversion circuit 104 is configured to receive the reference capacitance and total probe capacitance measurements and convert them into signals that may be used by processing circuit 106. In one embodiment, conversion circuit 104 may be configured to receive analog capacitance signals from capacitance sensor 102 and convert them into digital signals for use by processing circuit 106. According to various embodiments, conversion circuit 104 may be implemented using hardware components, software modules, or a combination thereof. In some embodiments, conversion circuit 104 may be a component of system 100 separate from processing circuit 106. In other embodiments, at least part of conversion circuit 104 may be implemented within processing circuit 106 (e.g., as a software module stored in a memory 108). According to various embodiments, conversion circuit 104 may output signals representing the reference capacitance and total probe capacitance serially, in parallel, etc.

Processing circuit 106 is configured to receive signals representative of the reference capacitance and total probe capacitance from conversion circuit 104 and determine the level of the fluid. Processing circuit includes a processor 109 and a memory 108. The capacitance signals are received at capacitance input 110. Processing circuit 106 uses the reference capacitance, which represents the capacitance of a predetermined level of fluid, to determine a capacitance per unit of fluid level, such as capacitance-per-inch. In some embodiments, other fluid level denominations (e.g., millimeters, tenths of an inch, half-inches, etc.) may be used. Because the capacitance measured across the fluid is substantially linearly related to the level of the fluid, processing circuit 106 is configured to use the total probe capacitance and the capacitance per inch to determine the level of the fluid. In some embodiments, the determined level of the fluid may be presented to a user on a display 116. Display 116 may be any type of display (LED, LCD, plasma, CRT, etc.) and may be positioned in any suitable location in vehicle 101 (e.g., in the passenger compartment so that it is visible to a driver of the vehicle).

Processing circuit 106 is also configured to determine whether the level of the fluid is below a threshold level based on one or more of attitude or tilt (e.g., pitch, roll and yaw, magnitude and angle (e.g., polar coordinates) in two or three dimensions, etc.; representation of attitude may be dependent upon the application) measurements of vehicle 101, temperature measurements of the fluid, and data stored in memory 108. Processing circuit 106 is configured to receive attitude and temperature measurements from attitude and temperature sensors at attitude input 112 and temperature input 114. Memory 108 contains data representing threshold level values for a threshold level of fluid at a plurality of different attitude and temperature conditions. Processing circuit 106 retrieves from memory 108 the threshold level value for an attitude and temperature similar to the measurements received at inputs 112 and 114, and compares the fluid level to the threshold level. If the fluid level is greater than the threshold level, the fluid is above the threshold level. If the fluid level is less than the threshold level, the fluid is below the threshold level. In some embodiments, if the level of the fluid is below the threshold level processing circuit 106 may be configured to activate an alarm on display 116.

Referring now to FIG. 2A, a perspective view of a fluid level sensor 200 (e.g., capacitance sensor 102 shown in FIG. 1) is shown according to an exemplary embodiment. Fluid level sensor 200 includes an outer tube 202 and inner tubes. The inner tubes include a main probe 203, a reference probe 206, and an insulator 208. Outer tube 202, main probe 203, and reference probe 206 are constructed from conductive material such as a metal (e.g., titanium or a titanium alloy, although other materials may be used according to other exemplary embodiments). In the exemplary embodiment shown in FIG. 2A, outer tube 202 and the inner tube formed by main probe 203 and reference probe 206 are coaxial concentric cylindrical tubes. In other embodiments, outer tube 202 and the inner tube may be formed of other cross-sectional shapes (e.g., rectangular, square, etc.). Reference probe 206 may have a reference probe length 212 (e.g., 0.5 inches, 0.75 inches, etc., based on the applicable dimensions needed). Fluid level sensor 200 is placed in a reservoir holding the fluid such that fluid level sensor 200 is at least partially immersed in the fluid. In some embodiments, fluid level sensor 200 may be positioned such that reference probe 206 is always fully immersed in the fluid.

Insulator 208 is configured to mechanically couple and electrically isolate main probe 203 from reference probe 206. Insulator 208 may have cutouts or notches to allow fluid to flow between the area above insulator 208 and the area below insulator 208. Insulator 208 may be a ring or bushing (e.g., machined, molded, etc.) positioned between main probe 203 and reference probe 206. Insulator 208 may be coupled to main probe 203 and reference probe 206 by fusing or welding insulator 208 to the probes (e.g., by induction heating, laser-welding, etc.) Insulator 208 may be constructed from any electrically insulating material. In one embodiment, insulator 208 may be constructed from plastic.

Referring now to FIG. 2B, a perspective view of a fluid level sensor 250 is shown according to an alternative exemplary embodiment. In the exemplary embodiment of FIG. 2B, an inner tube 252 is a continuous tube and an outer tube includes a main probe 254, a reference probe 256, and an insulator 258. Insulator 258 is configured to mechanically couple and electrically isolate main probe 254 and reference probe 256. According to other exemplary embodiments, the main probe and reference probe may be separate components of the fluid level sensor and may not be mechanically coupled by an insulator. For example, in one embodiment the main probe and reference probe may be one continuous material (e.g., ceramic) coated with conductive plating in two separate sections.

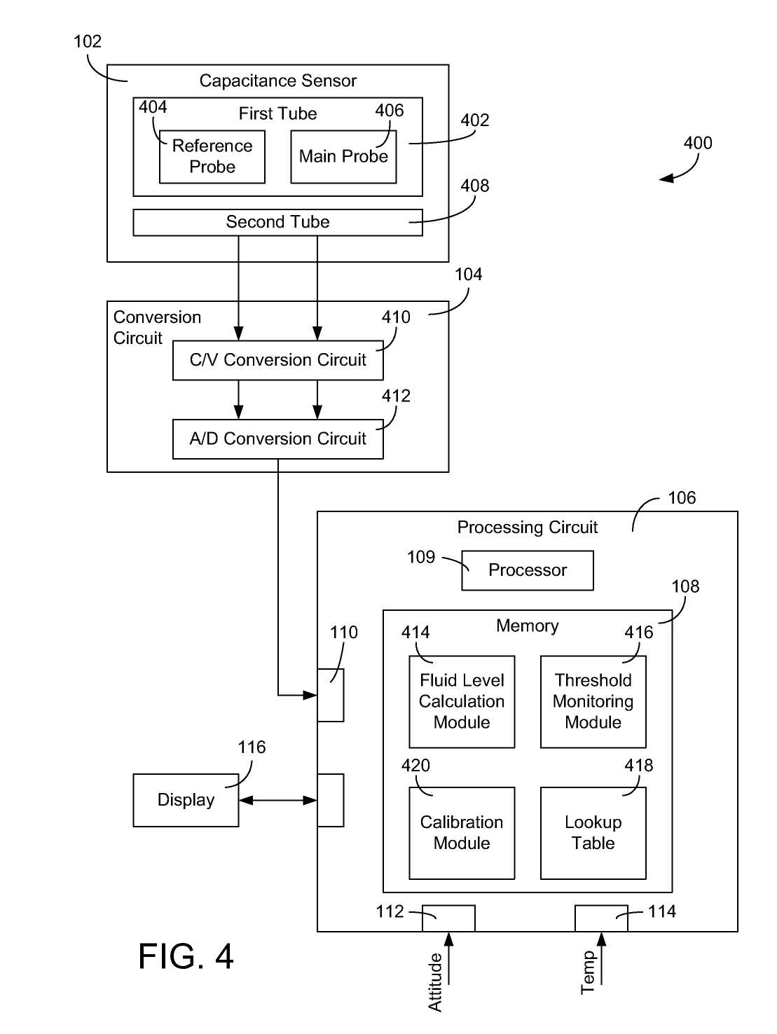

Referring now to FIG. 2C, a perspective view of fluid level sensor 200 partially immersed in a fluid 211 is shown according to an exemplary embodiment. Fluid level sensor 200 is shown positioned within a fluid reservoir 210. Fluid level sensor 200 may be positioned within fluid reservoir 210 using bolts, rods, bars, cables, and/or any other device for positioning fluid level sensor 200 within fluid reservoir 210. A volume of fluid 211 is contained in fluid reservoir 210 such that fluid 211 rises to a fluid level 214. Fluid level 214 is at a height 216 above the bottom of fluid level sensor 200. Fluid level sensor 200 is configured to measure a reference capacitance of a predetermined level of fluid 211 corresponding to reference probe length 212. According to one embodiment, reference probe length 212 is 0.5 inches and, when measured using the exemplary circuit shown in FIG. 3B, the reference probe capacitance is 40 Pico Farads (pF) in air and 45 pF in fluid. The reference probe is then said to measure 5 pF due to 0.5 inches of fluid or 10 pF per inch. Fluid level sensor 200 is also configured to measure a total probe capacitance of the actual level 214 of fluid 211 corresponding to height 216. According to one embodiment, capacitance when measured using the exemplary circuit shown in FIG. 3C is 50 pF in air and 60 pF in fluid at height 216. The main probe is then said to measure 10 pF due to the unknown level of fluid. The reference probe tells us the unknown fluid level must be 1.0 inches. A more detailed discussion of the calculation of unknown fluid levels using a fluid level sensor is provided herein with reference to the exemplary embodiment shown in FIG. 4.

Referring now to FIG. 2D, a perspective view of fluid level sensor 200 partially immersed in a fluid 211 is shown according to another exemplary embodiment. Fluid 211 fills fluid reservoir 210 to a level 218 that is higher than level 214 shown in FIG. 2C. The reference capacitance measured by fluid level sensor 210 is substantially the same as the reference capacitance measured by fluid level sensor 210 in the exemplary embodiment shown in FIG. 2C because the measurement is related to reference probe length 212. In the exemplary embodiment shown in FIG. 2D, fluid level sensor 200 is configured to measure a total probe capacitance of the actual level 218 of fluid 211 corresponding to height 220. According to one embodiment, height 220 is the unknown fluid level and measures 20 pF and the reference reading from the previous example conveys the same 10 pF per inch. This means the unknown fluid height 220 must be 2.0 inches.

Referring generally to FIGS. 3A through 3C, views of electrical connections to a fluid level sensor 300 are shown according to an exemplary embodiment. Referring particularly to FIG. 3A, fluid sensor 300 has an outer tube 302, a main probe 304, and a reference probe 306. Main probe 304 and reference probe 306 are mechanically coupled and electrically isolated by an insulator 307. Reference probe 306 is electrically connected to reference lead 308 and outer tube 302 is electrically connected to outer tube lead 310. Main probe 304 is electrically connected to main lead 312. Main lead 312 may be connected to reference lead 308 and/or outer tube lead 310 to electrically couple main probe 304 to reference probe 306 and/or outer tube 302, respectively. A switch, such as a relay or analog switch, may be used to change the connection of main lead 312.

Referring now to FIG. 3B, a view of electrical connections to fluid level sensor 300 is shown in which fluid level sensor 300 is configured to measure the capacitance of reference probe 306 (i.e., a reference capacitance). Main lead 312 is connected to outer tube lead 310, electrically coupling main probe 304 to outer tube 302. Reference probe 306 alone is connected to reference lead 308. In the configuration illustrated in FIG. 3B, the reference capacitance measured over leads 308 and 310 is the capacitance between reference probe 306 and the combination of outer tube 302 and main probe 304. If reference probe 306 is fully immersed in the fluid, the measured reference capacitance is the capacitance associated with a predetermined level of the fluid (i.e., the level of the fluid corresponding to the height of reference probe 306). Electrically coupling outer tube 302 and main probe 304 keeps main probe 304 from electrically floating and helps prevent variable capacitance effects of the unknown fluid level from affecting the reference capacitance measurement.

Referring now to FIG. 3C, a view of electrical connections to fluid level sensor 300 is shown in which fluid level sensor 300 is configured to measure a total probe capacitance. Main lead 312 is electrically connected to reference lead 308, electrically coupling main probe 304 to reference probe 306. In this configuration, the total probe capacitance measured over leads 308 and 310 is the capacitance between outer tube 302 and the combination of reference probe 306 and main probe 304. Accordingly, the measured total probe capacitance is the capacitance associated with the actual level of the fluid, including the height of reference probe 306 and the portion of main probe 304 that is immersed in the fluid.

Referring now to FIG. 3D, a graph 350 of the capacitance measured by fluid level sensor 300 shown in FIGS. 3A through 3C at different fluid levels is shown according to an exemplary embodiment. X-axis 354 of graph 350 represents the level of the fluid (e.g., in inches). Y-axis 352 of graph 350 represents the measured capacitance due to the fluid after subtracting capacitance in air (e.g., in pF). Reference curve 356 depicts the reference capacitance measured over leads 308 and 310 in the configuration shown in FIG. 3B as the level of the fluid increases. The measured reference capacitance increases substantially linearly with the level of the fluid from the bottom of fluid level sensor 300 to the top of reference probe 306, shown as level H_{R} on graph 350. The measured reference capacitance remains substantially constant (at a level C_{R} shown on graph 350) across fluid levels above H_{R}. If main probe 304 is not electrically coupled to outer tube 302 as shown in FIG. 3B, probe runaway due to stray capacitance or capacitive coupling between main probe 304 and reference probe 306 may cause the measured reference capacitance to increase with increasing fluid level rather than remain substantially constant. Main curve 358 depicts the total probe capacitance measured over leads 308 and 310 in the configuration shown in FIG. 3C as the level of the fluid increases. The measured total probe capacitance increases substantially linearly with the level of the fluid from the bottom to the top of fluid level sensor 300.

Referring now to FIG. 4, a more detailed block diagram of the system for determining a level of a fluid in a vehicle of FIG. 1 is shown according to an exemplary embodiment. According to the depicted exemplary embodiment, capacitance sensor 102 includes a first tube 402 and a second tube 408. First tube 402 includes a reference probe 404 and a main probe 406. In some embodiments, first tube 402, including reference probe 404 and main probe 406, and second tube 408 may be constructed as shown in the exemplary embodiments of FIGS. 2A and 2B and may be electrically connected as shown in FIGS. 3A through 3C. Capacitance sensor 102 is configured to measure a reference capacitance and a total probe capacitance using at least reference probe 404, main probe 406, and second tube 408 (e.g., as described with reference to FIGS. 3A through 3C) and transmit the measured capacitances to conversion circuit 104 for conversion into one or more signals that may be used by processing circuit 106.

Referring still to the exemplary embodiment of FIG. 4, conversion circuit 104 may include a capacitance-to-voltage (“C/V”) conversion circuit 410 and an analog-to-digital (“A/D”) conversion circuit 412 configured to convert the measured reference and total probe capacitances to one or more digital signals that may be used by processing circuit 106. C/V conversion circuit 410 may be a circuit configured to measure the reference and total probe capacitances using inputs from capacitance sensor 102 and convert the capacitance measurements into voltages to be transmitted to A/D conversion circuit 412. C/V conversion circuit 410 may include one or more charge-pump circuits. A charge-pump circuit may include a charge-pump reference capacitor and charge-pump reference voltage source, such that the output voltage of the charge-pump circuit is linear and directly proportional to the input capacitance. If the input capacitance is equal to the charge-pump reference capacitance the output voltage is equal to the charge-pump reference voltage. If the input capacitance is less than the charge-pump reference capacitance the output voltage is less than the charge-pump reference voltage. If the input capacitance is greater than the charge-pump reference capacitance the output voltage is greater than the charge-pump reference voltage. In one embodiment, C/V conversion circuit 410 may include two similar charge-pump circuits combined to provide near real-time or nearly simultaneous measurement of both reference capacitance and total probe capacitance. In such an embodiment, one charge-pump circuit may be configured to output a voltage associated with the measured reference capacitance and the other charge-pump circuit may be configured to output a voltage associated with the measured total probe capacitance.

C/V conversion circuit 410 may include a clock generator configured to generate a signal to switch or alternate between measuring reference capacitance (e.g., as shown in FIG. 3B) and total probe capacitance (e.g., as shown in FIG. 3C). In one embodiment, C/V conversion circuit 410 may be configured to alternate between measuring reference capacitance and total probe capacitance at a frequency of at least 5 kHz, such that alternation occurs less than approximately every 200 microseconds and a full measurement cycle (in which both reference capacitance and total probe capacitance are measured) is completed in less than approximately 400 microseconds. In other embodiments, alternation may occur at any other frequency, such as 12 kHz, 3 kHz, 500 Hz, etc.

A/D conversion circuit 412 is configured to receive the reference voltage and fluid voltage respectively corresponding to the reference capacitance and total probe capacitance measured using capacitance sensor 102 and convert them into digital signals to be used by processing circuit 106. A/D conversion circuit 412 may be any circuit capable of receiving an analog signal as an input and outputting a digital representation of the analog signal. A/D conversion circuit 412 may output a reference signal, corresponding to the measured reference capacitance, and a fluid signal, corresponding to the measured actual total probe capacitance, as a serial signal, separate parallel signals, in compressed or uncompressed form, or in any other manner for transmitting digital signals. Capacitance in pF units may not be convenient and an A/D conversion count number with a known conversion factor may be used instead. Capacitance is then referred to as counts. An exemplary conversion value may be 0.01175 pF per count for a high resolution of capacitance measure.

Processing circuit 106 is configured to receive the reference signal and fluid signal from conversion circuit 104 at capacitance input 110. In addition to data, memory 108 may contain one or more software modules configured to perform tasks when executed by processor 109, such as a fluid level calculation module 414, a threshold monitoring module 416, and a calibration module 420. Fluid level calculation module 414 is configured to determine the level of the fluid based on the reference signal and fluid signal received at capacitance input 110. Fluid level calculation module 414 first determines the reference capacitance (Ref_{F}) and total probe capacitance (Fluid_{F}) due to fluid by subtracting reference probe (Ref₀) and main probe (Main) zero values from the reference signal (Ref) and fluid signal (Fluid), respectively:

Ref_{F}=Ref−Ref₀

Fluid_{F}=Fluid−Main₀

The reference probe zero value is related to the capacitance of reference probe 404 in air and the main probe zero value is related to the capacitance of main probe 406 in air (i.e., when capacitance sensor 102 is not in contact with the fluid). The reference probe and main probe zero values may also be adjusted to account for stray capacitance associated with the respective probe, the probe geometry, and/or temperature effects.

Fluid level calculation module 414 then calculates a counts-per-inch or CPI value by dividing the reference capacitance due to fluid by the height (H_{Ref}) of reference probe 404:

CPI=Ref_{F}/H_{Ref}

For the purposes of this aspect of the exemplary embodiment, it is presumed that reference probe 404 is fully immersed in fluid. In some embodiments, the fluid level should be above a minimum level (e.g., 0.25 inches above the top of reference probe 404) to obtain an accurate CPI calculation. If the fluid level is below the minimum level, a historical CPI value may be used to calculate the current fluid level. The historical CPI value may be obtained from data in memory 108, such as one or more tables that store CPI values over a range of temperatures. Temperature changes may reduce the continued validity of a CPI value; an accurate CPI value may be valid for a short time (e.g., five minutes) if the temperature varies significantly but substantially longer if the temperature remains relatively constant. In other exemplary embodiments, processing circuit 106 may be configured to determine if reference probe 404 is not fully immersed in fluid (e.g., using sensors) and activate a low fluid level alarm and/or adjust the calculations based on the proportion of reference probe 404 that is immersed in fluid.

Fluid level calculation module 414 is configured to calculate the level of the fluid by dividing the actual capacitance due to fluid by the CPI:

Level=Fluid_{F}/CPI

Processing circuit 106 may be configured to store the level, CPI and/or other values in memory 108, present the level to a user on display 116, or perform other tasks based on the level of the fluid. The CPI, zero values and/or other values used in calculating the level of the fluid may be affected by temperature and movement of the vehicle. In some embodiments, system 400 may receive input from a tachometer of the vehicle and may be configured to measure the reference capacitance and total probe capacitance when the vehicle is idling.

Exemplary calculations that may be performed by fluid level calculation module 414 will now be described with reference to the exemplary embodiments of FIGS. 2C and 2D. Referring to FIG. 2C, according to one embodiment, reference probe length 212 may be 0.5 inches, height 216 is the unknown level, the reference signal (Ref) received from fluid level sensor 200 may be 4628, the fluid signal (Fluid) received from fluid level sensor 200 may be 5275, the reference probe zero value (Ref₀) of reference probe 206 may be 4290, and the main probe zero value (Main₀) of main probe 204 may be 4515. In this exemplary embodiment, fluid level calculation module 414 calculates the reference signal (Ref) and fluid signal (Fluid) as follows:

Ref_{F}=Ref−Ref₀=4628−4290=338

Fluid_{F}=Fluid−Main₀=5275−4515=760

Fluid level calculation module 414 calculates the CPI as follows:

CPI=Ref_{F}/H_{Ref}=338/0.5=676

Fluid level calculation module 414 then determines the actual level 214 of fluid 211 as follows:

Level=Fluid_{F}/CPI=760/676=1.12 inches

Referring now to FIG. 2D, according to one embodiment, reference probe length 212 may again be 0.5 inches, height 220 is the unknown level, the reference signal (Ref) received from fluid level sensor 200 may be 4739, the fluid signal (Fluid) received from fluid level sensor 200 may be 6351, the reference probe zero value (Ref₀) of reference probe 206 may be 4290, and the main probe zero value (Main₀) of main probe 204 may be 4515. In this exemplary embodiment, fluid level calculation module 414 calculates the reference signal (Ref) and fluid signal (Fluid) as follows:

Ref_{F}=Ref−Ref₀=4739−4290=449

Fluid_{F}=Fluid−Main₀=6351−4515=1836

Fluid level calculation module 414 calculates the CPI as follows:

CPI=Ref_{F}/H_{Ref}=449/0.5=898

Fluid level calculation module 414 then determines the actual level 214 of fluid 211 as follows:

Level=Fluid_{F}/CPI=1836/898=2.04 inches

Referring again to FIG. 4, processing circuit 106 may also include a threshold monitoring module 416 configured to determine if the level of the fluid is below a threshold level. The threshold level may represent a fluid level below or above which the vehicle may be damaged, a level at which the vehicle is characterized at a certain volume of fluid or fluid height under a full level (e.g., 2 quarts low), a level at which the vehicle is characterized at a certain volume of fluid or fluid height above a full level (e.g., 1 quart above a full level) or any other level which may be used by processing circuit 106 to perform a task or of which it may be important to alert a user of the vehicle. The attitude of the vehicle and the temperature of the fluid can affect the capacitance measured at capacitance sensor 102. For example, the dielectric constants of fluids are generally directly related to the temperature of the fluids such that the dielectric constants increase with increasing temperature. Threshold monitoring module 416 is configured to use attitude input 112 and temperature input 114 of processing circuit 106 to determine a current attitude (e.g., pitch and roll) of the vehicle and temperature of the fluid. Threshold monitoring module 416 is configured to utilize one or more lookup tables 418 stored in memory 108 to determine a threshold capacitance associated with conditions similar to the current attitude and temperature conditions of the vehicle and fluid.

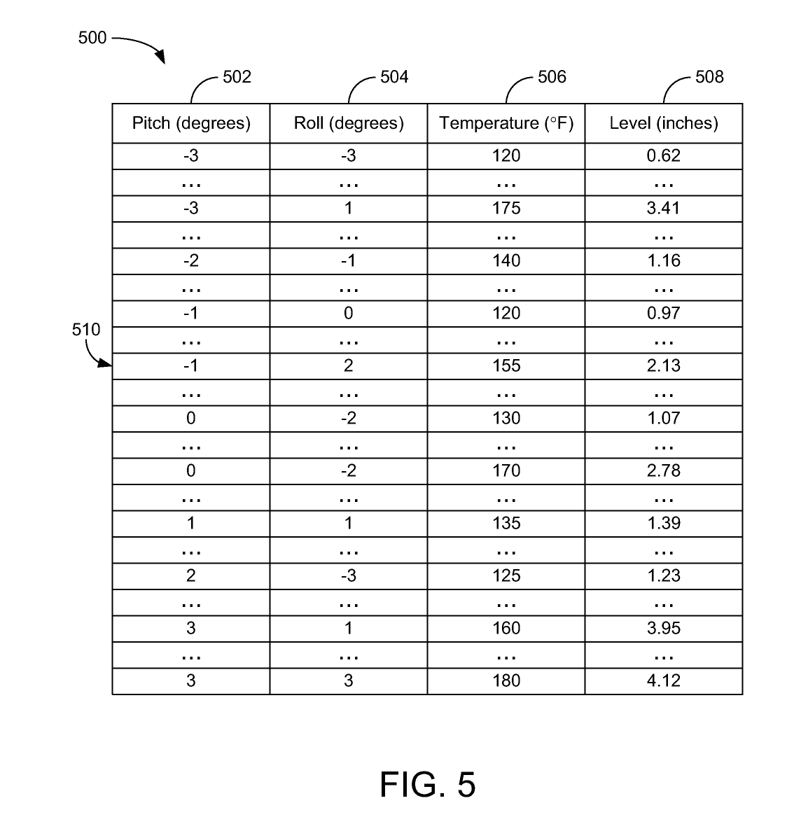

An exemplary lookup table 500 that may be utilized by threshold monitoring module 416 is illustrated in FIG. 5. Lookup table 500 includes a pitch column 502 and a roll column 504 representing the attitude of the vehicle in pitch and roll (in degrees). Lookup table 500 also includes temperature column 506 representing the temperature of the fluid. Lookup table 500 also includes level column 508 representing inches corresponding to a threshold level of fluid at the conditions displayed in columns 502, 504 and 506. Each row, for example row 510, represents one specific pitch (e.g., −1 degrees) and roll (e.g., 2 degrees) of the vehicle and temperature (155 degrees Fahrenheit) of the fluid, as well as the threshold level associated with that specific pitch, roll and temperature. The series of dots in between each row in lookup table 500 indicates the presence of intervening data rows that are not displayed in FIG. 5. In one embodiment, the pitch values of column 502 and roll values of column 504 may range from −3 to 3 degrees in 1 degree increments and the temperature values of column 506 may range from 120 to 200 degrees Fahrenheit in 5 degree increments. Accordingly, in such an embodiment, lookup table 500 includes one row for each combination of seven increments of pitch, seven increments of roll, and 17 increments of temperature, or 833 rows in total. In other embodiments, the values in columns 502, 504 and 506 may include values outside these ranges, include greater or lesser increments between values, include one or more irregular distributions of values rather than continuous incremental values, etc. The data of lookup table 500 may be stored in a memory in any data structure (e.g., array, linked list, queue, stack, tree, etc.). The values in between the pitch, roll, and temperature values shown in columns 502, 504, and 508 of FIG. 5 may be interpolated by processing circuit 106.

Referring again to the exemplary embodiment of FIG. 4, threshold monitoring module 416 is configured to compare the determined threshold level to the fluid level calculated from the capacitance sensor and received at capacitance input 110. If the calculated fluid level is greater than the threshold level, the fluid level is above the threshold level. If the calculated fluid level is less than the threshold level, the fluid level is below the threshold level. In some embodiments, processing circuit 106 may be configured to activate a low fluid alarm on display 116 or perform some other task if threshold monitoring module 416 determines that the fluid level is below the threshold level. In some exemplary embodiments, lookup table 418 may contain values associated with a plurality of threshold levels (e.g., 1 quart low, 2 quarts low, etc.) and threshold monitoring module 416 may be configured to determine if the level of the fluid is below one or more of the plurality of threshold levels.

Referring still to FIG. 4, processing circuit 106 may contain a calibration module 420 configured to calibrate processing circuit 106 and determine data used by other modules (e.g., fluid level calculation module 414 and/or threshold monitoring module 416) of processing circuit 106. Calibration module 420 may be configured to determine the main probe and reference probe zero values used by fluid level calculation module 414 and store them in memory 108. Calibration module 420 may determine the zero values based in part on the geometry of the respective probe and the fixed stray capacitance associated with the probe. In some embodiments, the zero values may be determined using linear projection from values obtained at different locations on the probe. The zero values may vary with temperature and calibration module 420 may be configured to alter the zero values based on the temperature received at temperature input 114 or to determine and store in memory 108 different zero values based on different temperatures. Calibration module 420 may also be configured to check the CPI value calculated by fluid level calculation module 414 and generate historical CPI data for use if the fluid level is below a minimum level.

Calibration module 420 may be configured to determine threshold level values with which to populate lookup table 418. By calibrating the threshold level values using calibration module 420, lookup table 418 may be populated with data specific to the particular vehicle. Calibration module 420 may determine threshold level values by calibration testing in the vehicle, by using preexisting values for a similar vehicle and/or engine type, by extrapolating values based on data for other vehicles, or by another method.

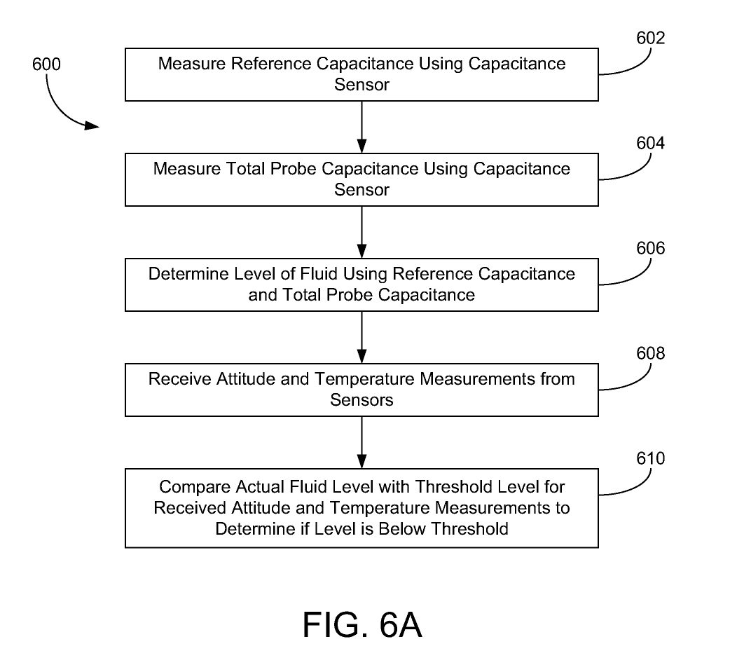

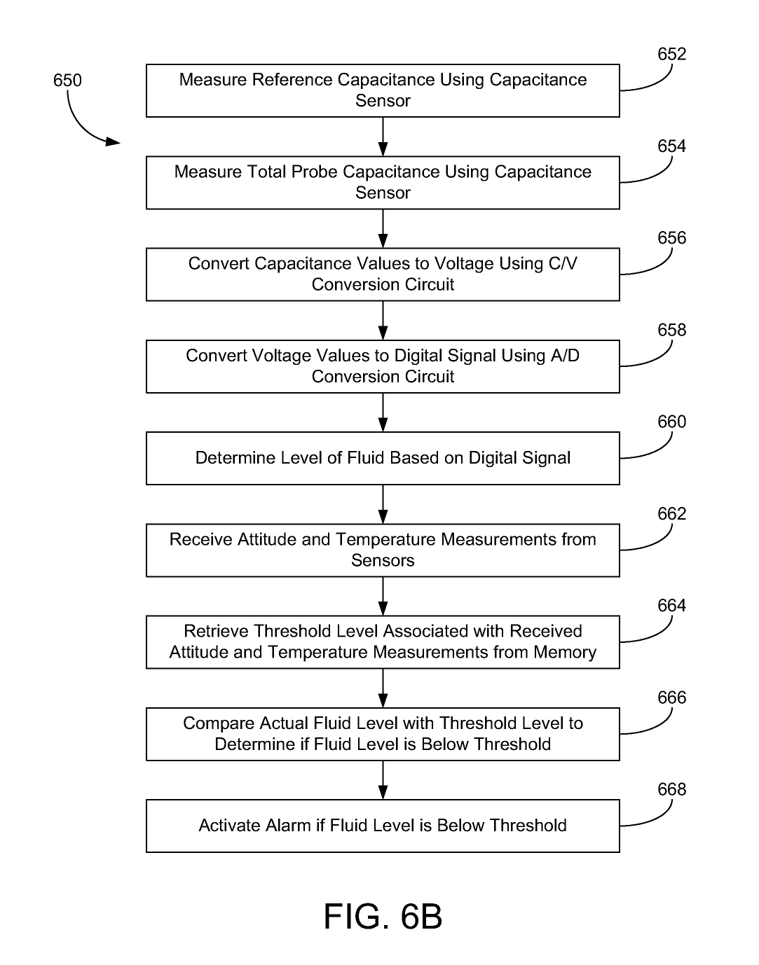

Referring now to FIG. 6A, a flow diagram of a process 600 for determining a level of a fluid in a vehicle (e.g., that may be executed by system 100 and/or 400) is shown according to an exemplary embodiment. Process 600 includes measuring a reference capacitance, representing the capacitance associated with a predetermined level of a fluid, using a capacitance sensor (e.g., capacitance sensor 102) (step 602). Process 600 further includes measuring a total probe capacitance, representing the capacitance associated with the actual level of the fluid, using the capacitance sensor (step 604). Process 600 is further shown to include determining the level of the fluid using the reference capacitance and the total probe capacitance (step 606). Process 600 further includes receiving attitude (e.g., pitch and roll) and temperature measurements from one or more sensors (step 608). Process 600 further includes determining a threshold level of fluid for conditions similar to the received attitude and temperature measurements and comparing the fluid level with the threshold level to determine if the fluid level is below the threshold level (step 610). In various embodiments, one or more of the steps of process 600 may be performed by various components of systems 100 and/or 400.

Referring now to FIG. 6B, a more detailed flow diagram of a process 650 for determining a level of a fluid in a vehicle is shown, according to an exemplary embodiment. In initial steps of process 650, capacitance values are measured using a capacitance sensor (e.g., capacitance sensor 102). Process 650 includes measuring a reference capacitance, representing the capacitance associated with a predetermined level of a fluid (step 652). Process 650 further includes measuring a total probe capacitance, representing the capacitance associated with the actual level of the fluid (step 654). According to various embodiments, the capacitance sensor may be constructed according to the exemplary embodiments shown in FIGS. 2A through 2D and the reference and total probe capacitances may be measured according to the exemplary methods described with reference to FIGS. 3A through 3C.

Once the reference and total probe capacitances have been measured they may be converted to digital signals that may be used by a processing circuit (e.g., processing circuit 106). The reference capacitance and total probe capacitance may be converted to voltages using a capacitance-to-voltage conversion circuit (e.g., CN conversion circuit 410) (step 656). The voltages may then be converted to one or more digital signals for use by the processing circuit using an analog-to-digital conversion circuit (e.g., A/D conversion circuit 412) (step 658).

Process 650 further includes determining the level of the fluid based on the signals received from the analog-to-digital conversion circuit by the processing circuit (step 660). The signal representing the reference capacitance may be used by the processing circuit to determine a CPI value, discussed with reference to the exemplary embodiment of FIG. 4. The level of the fluid may then be determined based on the signal representing the total probe capacitance and the CPI.

Once the actual fluid level has been determined it may be determined whether the fluid level exceeds a threshold level based on current conditions of the vehicle and/or fluid. Process 650 further includes receiving attitude and temperature measurements from one or more sensors (step 662). Process 650 is further shown to include retrieving a threshold level of fluid for conditions similar to those received in step 662 from a memory (e.g., memory 108) (step 664). Process 650 further includes comparing the calculated fluid level with the threshold level to determine if the fluid level is below the threshold level (step 666). Process 650 may include activating an alarm (e.g., on a display such as display 116) to alert a user of the vehicle if the fluid level is below the threshold level.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the fluid level sensing system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. In one alternative exemplary embodiment (e.g., for use in a pressurized zero-G fuel tank), one or more of the probes may measure a spherical geometry. Elements shown as integrally formed may be constructed of multiple parts or elements, the position of elements may be reversed or otherwise varied, and the nature or number of discrete elements or positions may be altered or varied (e.g., fluid and air assuming spherical geometries and air being replaced by pressurized gas). The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

The present disclosure contemplates methods, systems and program products on any machine-readable media for accomplishing various operations. The embodiments of the present disclosure may be implemented using existing integrated circuits, computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. In one embodiment, machine-executable instructions may be part of a firmware stored on a flash memory of a controller (e.g., memory 108 of processing circuit 106 as shown in the exemplary embodiments of FIGS. 1 and 4). In another embodiment, one or more of the probes may include a memory (e.g., a flash memory) and one or more values (e.g., calibration values such as the zero values described above) may be stored in the memory. In such an embodiment, the probes may be configured to supply their own calibration values from this on-probe memory to allow easier probe replacement in the field. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for monitoring a level of a fluid in a vehicle, the system comprising:
a capacitance sensor configured to be at least partially immersed in the fluid, wherein the capacitance sensor is configured to measure a first capacitance associated with a predetermined level of the fluid and a second capacitance associated with an actual level of the fluid in the vehicle; and
a processing circuit configured to determine the actual level of the fluid in the vehicle using the first capacitance and the second capacitance, wherein the processing circuit is configured to receive at least one of an attitude of the vehicle and a temperature of the fluid from at least one sensor coupled to the vehicle, wherein the processing circuit is configured to compare the determined actual level of the fluid with a threshold level associated with the at least one of the attitude and temperature to identify a relative position of the determined actual level with respect to the threshold level.

2. The system of claim 1, wherein the capacitance sensor comprises a first tube and a second tube, the first tube being concentric and coaxial with the second tube, wherein the second tube comprises a main probe and a reference probe, the main probe being positioned above the reference probe and being coupled to and electrically isolated from the reference probe, wherein the reference probe is configured to be completely immersed in the fluid, wherein the main probe is electrically coupled to the first tube to measure the first capacitance and the first capacitance is measured across the reference probe and the combination of the main probe and the first tube, wherein the main probe is electrically coupled to the reference probe to measure the second capacitance and the second capacitance is measured across the first tube and the combination of the main probe and reference probe.

3. The system of claim 2, wherein the second tube is outside of the first tube.

4. The system of claim 1, further comprising a conversion circuit configured to convert the first capacitance and second capacitance into at least one digital signal, wherein the conversion circuit comprises a charge pump circuit configured to convert the first capacitance and the second capacitance into a first voltage and a second voltage, wherein the conversion circuit further comprises an analog-to-digital conversion circuit configured to convert the first voltage and the second voltage into the at least one digital signal.

5. The system of claim 1, wherein the fluid is a nonconductive fluid.

6. The system of claim 1, wherein the processing circuit is further configured to retrieve data from a memory, the data comprising a plurality of threshold level data elements, wherein each threshold level data element represents a threshold level of fluid corresponding to different values of the at least one of the attitude and temperature, wherein the processing circuit is configured to retrieve a threshold level data element corresponding to a value of the at least one of the attitude and temperature similar to the value of the at least one of the attitude and temperature received from the at least one sensor, wherein the processing circuit is configured to identify the relative position of the determined actual level of the fluid with respect to the threshold level by comparing the determined actual level of the fluid to the retrieved threshold level data element.

7. The system of claim 1, wherein the processing circuit is configured to activate an alarm based on the comparison of the determined actual level of the fluid with the threshold level, wherein the alarm indicates that the fluid is below the threshold level when the threshold level represents a level below a full level of the vehicle, wherein the alarm indicates that the fluid is above the threshold level when the threshold level represents a level above the full level of the vehicle.

8. The system of claim 1, wherein the threshold level is one of a plurality of threshold levels, wherein each of the plurality of threshold levels represents a different level of the fluid in the vehicle.

9. A method for monitoring a level of a fluid in a vehicle, the method comprising:
measuring a first capacitance using a capacitance sensor, wherein the capacitance sensor is configured to be at least partially immersed in the fluid, the first capacitance being associated with a predetermined level of the fluid;
measuring a second capacitance using the capacitance sensor, the second capacitance being associated with an actual level of the fluid in the vehicle;
determining the actual level of the fluid in the vehicle based on the first capacitance and the second capacitance;
receiving at least one of an attitude of the vehicle and a temperature of the fluid from at least one sensor coupled to the vehicle; and
comparing the determined actual level of the fluid with a threshold level associated with the at least one of the attitude and temperature to identify a relative position of the determined actual level with respect to the threshold level.

10. The method of claim 9, wherein the capacitance sensor comprises a first tube and a second tube, the first tube being concentric and coaxial with the second tube, wherein the second tube comprises a main probe and a reference probe, the main probe being positioned above the reference probe and being coupled to and electrically isolated from the reference probe, wherein the reference probe is configured to be completely immersed in the fluid, wherein the main probe is electrically coupled to the first tube to measure the first capacitance and the first capacitance is measured across the reference probe and the combination of the main probe and the first tube, wherein the main probe is electrically coupled to the reference probe to measure the second capacitance and the second capacitance is measured across the first tube and the combination of the main probe and reference probe.

11. The method of claim 10, wherein the second tube is outside of the first tube.

12. The method of claim 9, further comprising converting the first capacitance and the second capacitance into at least one digital signal for use by a processing circuit, wherein the conversion circuit comprises a charge pump circuit configured to convert the first capacitance and the second capacitance into a first voltage and a second voltage, wherein the conversion circuit further comprises an analog-to-digital conversion circuit configured to convert the first voltage and the second voltage into the at least one digital signal.

13. The method of claim 9, wherein the fluid is a nonconductive fluid.

14. The method of claim 9, further comprising:
retrieving data from a memory, the data comprising a plurality of threshold level data elements, wherein each threshold level data element represents a threshold level of fluid corresponding to different values of the at least one of the attitude and temperature, wherein retrieving data from the memory comprises retrieving a threshold level data element corresponding to a value of the at least one of the attitude and temperature similar to the value of the at least one of the attitude and temperature received from the at least one sensor,
wherein comparing the determined actual level of the fluid with the threshold level comprises comparing the determined actual level of the fluid to the retrieved threshold level data element.

15. The method of claim 9, further comprising activating an alarm based on the comparison of the determined actual level of the fluid with the threshold level, wherein the alarm indicates that the fluid is below the threshold level when the threshold level represents a level below a full level of the vehicle, wherein the alarm indicates that the fluid is above the threshold level when the threshold level represents a level above the full level of the vehicle.

16. The method of claim 9, wherein the threshold level is one of a plurality of threshold levels, wherein each of the plurality of threshold levels represents a different level of the fluid in the vehicle.

17. A system for monitoring a level of a non-conductive fluid in a vehicle, the system comprising:
a capacitance sensor configured to be at least partially immersed in the fluid, the capacitance sensor comprising an outer tube and an inner tube, the outer tube being concentric and coaxial with the inner tube, wherein the inner tube comprises a main probe and a reference probe, the main probe being positioned above the reference probe and being coupled to and electrically isolated from the reference probe by an insulator, wherein the reference probe is configured to be completely immersed in the fluid, wherein the capacitance sensor is configured to measure a first capacitance and a second capacitance, the first capacitance being associated with a predetermined level of the fluid, the second capacitance being associated with an actual level of the fluid in the vehicle, wherein the main probe is electrically coupled to the outer tube to measure the first capacitance and the first capacitance is measured across the reference probe and the combination of the main probe and the outer tube, wherein the main probe is electrically coupled to the reference probe to measure the second capacitance and the second capacitance is measured across the outer tube and the combination of the main probe and reference probe;
a conversion circuit configured to convert the first capacitance and the second capacitance to digital signals; and
a processing circuit configured to determine the actual level of the fluid using the digital signals representing the first capacitance and the second capacitance, wherein the processing circuit is configured to receive at least one of an attitude of the vehicle and a temperature of the fluid from at least one sensor coupled to the vehicle, wherein the processing circuit includes a memory configured to store a plurality of threshold level data elements, wherein each threshold level data element represents a threshold level of the fluid corresponding to different values of the at least one of the attitude and temperature, wherein the processing circuit is configured to retrieve a threshold level data element corresponding to a value of the at least one of the attitude and temperature similar to the value of the at least one of the attitude and temperature received from the at least one sensor, wherein the processing circuit is configured to compare the determined actual level of the fluid with the retrieved threshold level data element to identify a relative position of the determined actual level of the fluid with respect to the threshold level.

18. The system of claim 17, wherein the conversion circuit comprises a charge pump circuit configured to convert the first capacitance and the second capacitance into a first voltage and a second voltage, wherein the conversion circuit further comprises an analog-to-digital conversion circuit configured to convert the first voltage and the second voltage into the at least one digital signal.

19. The system of claim 17, wherein the processing circuit is configured to activate an alarm based on the comparison of the determined actual level of the fluid with the retrieved threshold level data element, wherein the alarm indicates that the fluid is below the threshold level when the threshold level represents a level below a full level of the vehicle, wherein the alarm indicates that the fluid is above the threshold level when the threshold level represents a level above the full level of the vehicle.

20. They system of claim 17, wherein the threshold level is one of a plurality of threshold levels, wherein each of the plurality of threshold levels represents a different level of the fluid in the vehicle.
